(19) United States
(12) Patent Application Publication
(10) Pub. No.: US 2022/0232691 A1
(43) Pub. Date: Jul. 21, 2022

(54) INDUCTIVELY COUPLED PLASMA TORCHES AND METHODS AND SYSTEMS INCLUDING SAME

(71) Applicant: PerkinElmer Health Sciences Canada, Inc., Woodbridge (CA)

(72) Inventors: Tak Shun Cheung, Toronto (CA); Chui Ha Cindy Wong, Markham (CA); William Fisher, Cookstown (CA); Hamid R. Badiei, Woodbridge (CA)

(21) Appl. No.: 17/152,507

(22) Filed: Jan. 19, 2021

(51) Int. Cl. H05H 1/46

(52) U.S. Cl. CPC H05H 1/46; H05H 2001/469; H05H 2001/466

(57) ABSTRACT

An ICP torch includes an injector tube defining an injector flow passage to receive a flow of a sample fluid, an intermediate tube disposed about the injector tube, a plasma tube disposed about the intermediate tube, and an induction coil disposed about the plasma tube. An auxiliary gas passage is defined between the injector tube and the intermediate tube to receive a flow of an auxiliary gas. A plasma gas passage is defined between the intermediate tube and the plasma tube to receive a flow of a plasma gas. The induction coil can produce a plasma proximate a torch distal end. The induction coil extends axially from a coil proximal end to a coil distal end proximate the torch distal end. The plasma tube includes an outlet opening proximate the torch distal end. The outlet opening is at least partially coincident with or axially inset from the coil distal end.

### FIELD

The present technology relates to plasma sources and, more particularly, to inductively coupled plasma torches.

### BACKGROUND

An inductively coupled plasma (ICP) torch system is a type of plasma source in which energy is supplied by electric currents that are produced by electromagnetic induction. ICP torch systems are used in some analytical instruments to ionize a sample.

### SUMMARY

In one aspect, an inductively coupled plasma (ICP) torch has a torch axis and a torch distal end. The ICP torch includes an injector tube, an intermediate tube, a plasma tube, and an induction coil. The injector tube defines an injector flow passage to receive a flow of a sample fluid. The intermediate tube is disposed about the injector tube. An auxiliary gas passage is defined between the injector tube and the intermediate tube and configured to receive a flow of an auxiliary gas. The plasma tube is disposed about the intermediate tube. A plasma gas passage is defined between the intermediate tube and the plasma tube and configured to receive a flow of a plasma gas. The induction coil is disposed about the plasma tube. The induction coil is configured to be supplied with radio-frequency electric current to inductively energize the auxiliary gas to produce a plasma proximate the torch distal end. The induction coil extends axially from a coil proximal end to a coil distal end proximate the torch distal end. The plasma tube includes an outlet opening proximate the torch distal end. The outlet opening is at least partially coincident with or axially inset from the coil distal end.

In some embodiments, the outlet opening of the plasma tube is coincident with the coil distal end.

In some embodiments, the outlet opening of the plasma tube is axially inset from the coil distal end.

According to some embodiments, the outlet opening of the plasma tube is axially inset from the coil distal end a distance in the range of from about 1 mm to about 5 mm.

According to some embodiments, the outlet opening of the plasma tube is disposed within the induction coil.

In some embodiments, a distal end of the plasma tube is coincident with or axially inset from the coil distal end.

In some embodiments, the distal end of the plasma tube is coincident with the coil distal end.

According to some embodiments, the distal end of the plasma tube is axially inset from the coil distal end.

In some embodiments, the distal end of the plasma tube is axially inset from the coil distal end a distance in the range of from about 1 mm to about 5 mm.

According to some embodiments, the distal end of the plasma tube is disposed within the induction coil.

According to some embodiments, the outlet opening is located at a distal end of the plasma tube and is aligned with the torch axis.

In some embodiments, the outlet opening is a radial side opening in the plasma tube.

In some embodiments, the plasma tube includes a distal terminal end opening aligned with the torch axis, and the radial side opening intersects the distal terminal end opening.

According to some embodiments, the auxiliary gas passage has a narrowed gap proximate a distal end of the auxiliary tube.

In some embodiments, the plasma tube is formed of quartz.

According to some embodiments, the plasma tube is formed of an opaque material.

In some embodiments, the opaque material is selected from the group consisting of silicon nitride or ceramic.

The ICP torch may include an ignition electrode disposed radially external of the plasma tube and operable to ignite a plasma in the flow of the auxiliary gas.

The ICP torch may include a confining gas tube disposed about the plasma tube, wherein a confining gas passage is defined between the plasma tube and the confining gas tube to receive a flow of a confining gas.

According to some embodiments, the confining gas tube protrudes distally beyond a distal end of the plasma tube.

In some embodiments, the confining gas tube protrudes distally beyond a distal end of the plasma tube a distance in the range of from about 2 mm to about 9 mm.

According to some embodiments, a distal end of the confining gas tube is coincident with or protrudes distally beyond the coil distal end.

In some embodiments, the distal end of the confining gas tube is coincident with the coil distal end.

In some embodiments, the distal end of the confining gas tube protrudes distally beyond the coil distal end.

According to some embodiments, a distal end of the plasma tube is coincident with or axially inset from the coil distal end.

The ICP torch may include multiple inlets configured to direct the confining gas into the confining gas passage.

The ICP torch may include an inlet to direct the confining gas into the confining gas passage in a direction that substantially radially intersects the torch axis.

The ICP torch may include an inlet to direct the confining gas into the confining gas passage in a direction that is transverse to and radially offset from the torch axis.

In some embodiments, the confining gas tube is removably attached to the plasma tube.

The ICP torch may include an annular ring between the confining gas tube and the plasma tube.

According to some embodiments, the confining gas tube comprises at least one of quartz, borosilicate glass, Pyrex glass, or ceramic.

In another aspect, a method for generating a plasma includes providing an inductively coupled plasma (ICP) torch having a torch axis and a torch distal end. The ICP torch includes: an injector tube defining an injector flow passage to receive a flow of a sample fluid; an intermediate tube disposed about the injector tube, wherein an auxiliary gas passage is defined between the injector tube and the intermediate tube and configured to receive a flow of an auxiliary gas; a plasma tube disposed about the intermediate tube, wherein a plasma gas passage is defined between the intermediate tube and the plasma tube and configured to receive a flow of a plasma gas; and an induction coil disposed about the plasma tube, the induction coil extending axially from a coil proximal end to a coil distal end proximate the torch distal end. The plasma tube includes an outlet opening proximate the torch distal end. The outlet opening is at least partially coincident with or axially inset from the coil distal end. The method further includes: flowing the auxiliary gas through the auxiliary gas passage; flowing the plasma gas through the plasma gas passage; and supplying a radio-frequency electric current to the induction coil to inductively energize the auxiliary gas to produce a plasma proximate the torch distal end.

In another aspect, an inductively coupled plasma (ICP) torch has a torch axis and a torch distal end. The ICP torch includes an injector tube, an intermediate tube, a plasma tube, and a confining gas tube. The injector tube defines an injector flow passage to receive a flow of a sample fluid. The intermediate tube is disposed about the injector tube. An auxiliary gas passage is defined between the injector tube and the intermediate tube and configured to receive a flow of an auxiliary gas. The plasma tube is disposed about the intermediate tube. A plasma gas passage is defined between the intermediate tube and the plasma tube and configured to receive a flow of a plasma gas. The confining gas tube is disposed about the plasma tube. A confining gas passage is defined between the plasma tube and the confining gas tube to receive a flow of a confining gas. The confining gas tube protrudes distally beyond a distal end of the plasma tube.

The ICP torch may include multiple inlets configured to direct the confining gas into the confining gas passage.

The ICP torch may include an inlet to direct the confining gas into the confining gas passage in a direction that substantially radially intersects the torch axis.

The ICP torch may include an inlet to direct the confining gas into the confining gas passage in a direction that is transverse to and radially offset from the torch axis.

In some embodiments, the confining gas tube comprises at least one of quartz, borosilicate glass, Pyrex glass, or ceramic.

According to some embodiments, the plasma tube and the confining gas tube are formed of different materials from one another.

In some embodiments, the confining gas tube is transparent or translucent.

In some embodiments, the plasma tube is opaque.

The ICP torch may include an induction coil disposed about the plasma tube. The induction coil is configured to be supplied with radio-frequency electric current to inductively energize the auxiliary gas to produce a plasma proximate the torch distal end. The induction coil extends axially from a coil proximal end to a coil distal end proximate the torch distal end.

In some embodiments, a distal end of the confining gas tube is coincident with or protrudes distally beyond the coil distal end.

In some embodiments, the distal end of the confining gas tube is coincident with the coil distal end.

In some embodiments, the distal end of the confining gas tube protrudes distally beyond the coil distal end.

In a further aspect, an inductively coupled plasma (ICP) torch system includes an ICP torch having a torch axis and a torch distal end. The ICP torch includes an injector tube, an intermediate tube, a plasma tube, an induction coil, and a confining gas tube. The injector tube defines an injector flow passage to receive a flow of a sample fluid. The intermediate tube is disposed about the injector tube. An auxiliary gas passage is defined between the injector tube and the intermediate tube and configured to receive a flow of an auxiliary gas. The plasma tube is disposed about the intermediate tube. A plasma gas passage is defined between the intermediate tube and the plasma tube and configured to receive a flow of a plasma gas. The induction coil is disposed about the plasma tube. The induction coil is configured to be supplied with radio-frequency electric current to inductively energize the auxiliary gas to produce a plasma proximate the torch distal end. The induction coil extends axially from a coil proximal end to a coil distal end proximate the torch distal end. The confining gas tube is disposed about the plasma tube. A confining gas passage is defined between the plasma tube and the confining gas tube to receive a flow of a confining gas. The confining gas tube protrudes distally beyond a distal end of the plasma tube. The ICP torch system further includes a supply of the auxiliary gas fluidly coupled to the auxiliary gas passage, a supply of the plasma gas fluidly coupled to the plasma gas passage, and a supply of the confining gas fluidly coupled to the confining gas passage.

In some embodiments, the confining gas has a different chemical composition than the plasma gas.

According to some embodiments, the confining gas includes nitrogen gas.

In some embodiments, the plasma gas includes argon gas.

The ICP torch system may include a positive pressure source configured to supply the confining gas into the confining gas passage with a positive pressure to force the confining gas to flow through the confining gas passage.

In some embodiments, the ICP torch system is configured to use a negative pressure to draw a flow of the confining gas through the confining gas passage.

In a further aspect, a method for generating a plasma includes providing an inductively coupled plasma (ICP) torch having a torch axis and a torch distal end. The ICP torch includes: an injector tube defining an injector flow passage to receive a flow of a sample fluid; an intermediate tube disposed about the injector tube, wherein an auxiliary gas passage is defined between the injector tube and the intermediate tube and configured to receive a flow of an auxiliary gas; a plasma tube disposed about the intermediate tube, wherein a plasma gas passage is defined between the intermediate tube and the plasma tube and configured to receive a flow of a plasma gas; and an induction coil disposed about the plasma tube, the induction coil extending axially from a coil proximal end to a coil distal end proximate the torch distal end; and a confining gas tube disposed about the plasma tube. A confining gas passage is defined between the plasma tube and the confining gas tube to receive a flow of a confining gas. The confining gas tube protrudes distally beyond a distal end of the plasma tube. The method further includes: flowing the auxiliary gas through the auxiliary gas passage; flowing the plasma gas through the plasma gas passage; flowing the confining gas through the confining gas passage; and supplying a radio-frequency electric current to the induction coil to inductively energize the auxiliary gas to produce a plasma proximate the torch distal end. The confining gas surrounds the plasma in a confinement zone located distally beyond the distal end of the plasma tube.

In some embodiments, at least a portion of the confinement zone is disposed within the induction coil.

The method may include flowing the plasma gas through the plasma gas passage at a volumetric flow rate of less than 10 liters/minute.

The method may include flowing the confining gas through the confining gas passage at a volumetric flow rate of at least 7 liters/minute.

### BRIEF DESCRIPTION OF THE DRAWINGS

The accompanying drawings, which form a part of the specification, illustrate embodiments of the technology.

FIG. 1 is an illustration of an ICP torch system according to some embodiments.

FIG. 2 is an illustration of an ICP torch system according to further embodiments.

FIG. 3 is an enlarged, fragmentary illustration of the ICP torch system of FIG. 2.

FIG. 4 is a cross-sectional view of the ICP torch system of FIG. 2 taken along the line 4-4 of FIG. 3.

FIG. 5 is an illustration of an ICP torch system according to further embodiments.

FIG. 6 is an illustration of an ICP torch according to further embodiments.

FIG. 7 is an illustration of an ICP torch according to further embodiments.

FIG. 8 is an illustration of an ICP torch according to further embodiments.

FIG. 9 is an illustration of an ICP torch according to further embodiments.

FIG. 10 is an illustration of an ICP torch according to further embodiments.

FIG. 11 is an illustration of an ICP torch according to further embodiments.

FIG. 12 is an illustration of an ICP torch according to further embodiments.

FIG. 13 is a cross-sectional view of the ICP torch of FIG. 12 taken along the line 13-13 of FIG. 12.

FIG. 14 is an illustration of an ICP torch according to further embodiments.

FIG. 15 is an illustration of a mass spectroscopy system including an ICP torch system according to some embodiments.

FIG. 16 is an illustration of an optical emission spectroscopy system including an ICP torch system according to some embodiments.

FIG. 17 is an illustration of an atomic absorption spectroscopy system including an ICP torch system according to some embodiments.

### DETAILED DESCRIPTION

Conventional ICP torches include an injector tube, an intermediate tube surrounding the injector tube, a plasma tube surrounding the intermediate tube, and an induction coil surrounding the plasma tube. A sample gas is flowed through the injector tube, an auxiliary gas is flowed between the injector tube and the intermediate tube, and a plasma gas is flowed between the intermediate tube and the plasma tube. A plasma is generated from the auxiliary gas within the induction coil. The plasma tube extends beyond a distal end of the induction coil to protect the induction coil from the hot plasma within the torch. Even though the plasma tube is made from a material that can withstand high temperature (e.g., quartz), the plasma tube may melt if the plasma is too close to the plasma tube. For this reason, the plasma gas is flowed through the plasma tube to cool the plasma tube and provide a buffer between the plasma and the plasma tube.

However, the plasma gas typically must be flowed at a high velocity and volumetric flow rate to prevent the plasma gas from assuming a plasma state, and to cool the plasma tube sufficiently to prevent melting of the plasma tube. Argon is commonly used as the plasma gas, and the high consumption of Argon gas can significantly increase the operating cost of the ICP torch.

Apparatus and methods according to embodiments of the technology can address shortcomings of conventional ICP torches. In particular, apparatus and methods according to embodiments of the technology can enable the use of lower volumetric flow rates of a plasma gas while still preventing the plasma tube from melting. As a result, apparatus and methods according to embodiments of the technology can reduce the required consumption of the plasma gas (e.g., argon).

In a first aspect, an ICP torch according to embodiments of the technology includes an injector tube, an intermediate tube, a plasma tube, and an induction coil. The injector tube defines an injector flow passage through which a sample fluid is flowed toward a distal end of the torch (herein referred to as the forward direction). The intermediate tube is disposed about the injector tube to define an auxiliary gas passage between the injector tube and the intermediate tube. An auxiliary gas is flowed through the auxiliary gas passage in the forward direction. The plasma tube is disposed about the intermediate tube to define a plasma gas passage between the intermediate tube and the plasma tube. A plasma gas is flowed through the plasma gas passage in the forward direction. The induction coil is disposed about the plasma tube. The plasma tube includes an outlet opening proximate the distal end of the torch. The outlet opening is at least partially coincident with or axially inset from a distal end of the coil. In some embodiments, a distal end or tip of the plasma tube is coincident with or axially inset from the distal end of the coil.

In use, the plasma becomes progressively hotter in the forward direction. As a result, the plasma tube is subjected to progressively hotter plasma in the forward direction. The placement of the outlet or tip of the plasma tube at or inset from the coil distal end effectively shortens the length of the plasma tube extending along the plasma, and increases the axial distance between the tip of the plasma tube and the hottest portion of the plasma. In this way, heating of the tip of the plasma tube is reduced. Because less heat is transferred to the plasma tube, less plasma gas is required to cool the plasma tube to prevent melting of the plasma tube.

In a second aspect, an ICP torch according to embodiments of the technology includes an injector tube, an intermediate tube, a plasma tube, a confining gas tube, and an induction coil. The injector tube defines an injector flow passage through which a sample fluid is flowed toward a distal end of the torch (herein referred to as the forward direction). The intermediate tube is disposed about the injector tube to define an auxiliary gas passage between the injector tube and the intermediate tube. An auxiliary gas is flowed through the auxiliary gas passage in the forward direction. The plasma tube is disposed about the intermediate tube to define a plasma gas passage between the intermediate tube and the plasma tube. A plasma gas is flowed through the plasma gas passage in the forward direction. The confining gas tube is disposed about the plasma tube to define a confining gas passage. A confining gas is flowed through the confining gas passage in the forward direction. The confining gas tube protrudes distally beyond a distal end of the plasma tube. The induction coil is disposed about the confining gas tube. In use, the confining gas flow forms a tubular confining gas curtain, buffer or sheath surrounding the plasma gas stream and the plasma. The confining gas sheath serves to shield the induction coil and the confining gas tube from the heat of the plasma. The confining gas sheath may also serve to cool the confining gas tube.

In a third aspect, an ICP torch according to embodiments of the technology is constructed as described for the second aspect in combination with the first aspect (i.e., the plasma tube outlet opening or tip is coincident with or axially inset from a distal end of the coil). In this case, the confining gas tube and the confining gas sheath surround the plasma in the region axially beyond plasma tube outlet opening or tip, thereby shielding the induction coil from the portions of the plasma not surrounded by the plasma tube.

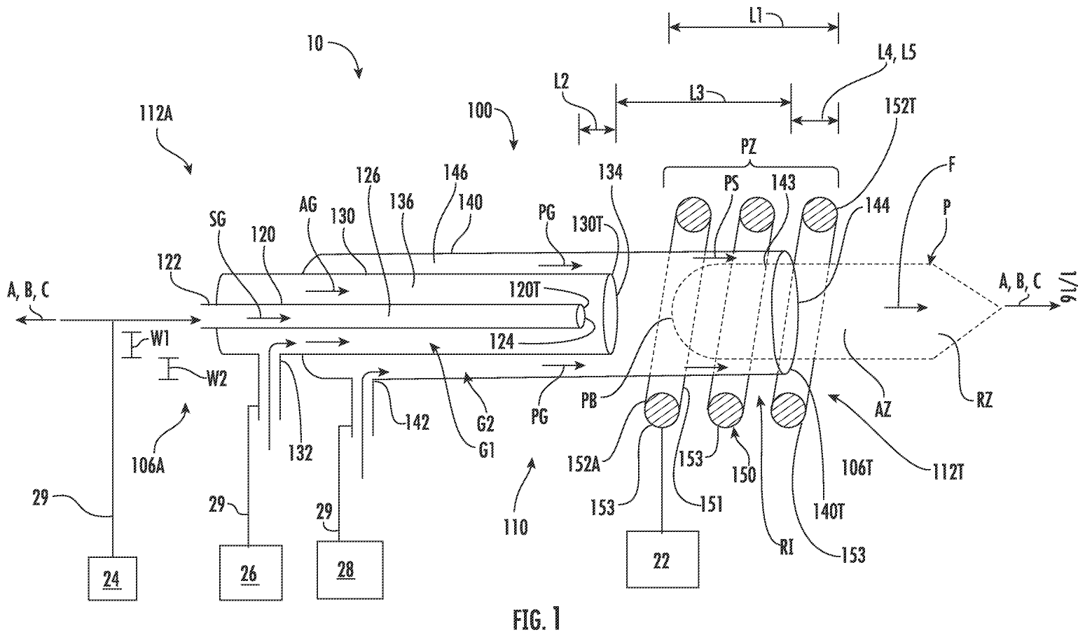

With reference to FIG. 1, an ICP torch system 10 according to some embodiments is shown therein. The ICP torch system 10 includes a torch 100, a radiofrequency power generator (electrical power supply) 22, a sample source 24, an auxiliary gas source 26, and a plasma gas source 28. In use, a sample flow or stream SG (from the sample source 24), an auxiliary gas flow or stream AG (from the auxiliary gas source 26), and a plasma gas flow or stream PG (from the plasma gas source 28) are each forced or flowed through the torch 100 in a forward direction F toward a distal end 106T of the torch 100. The ICP torch system 10 generates a plasma P at the distal end 106T from the auxiliary gas AG.

The plasma P may serve as an ionization source. In some embodiments, the plasma P decomposes a sample from the sample stream SG into its constituent elements and transforms those elements into ions. The sample may be an analyte of interest.

The sample source 24 may include a supply of a sample to be analyzed. The sample of interest may be provided in a solution or mixture. The sample source 24 may include an injector, nebulizer or other suitable device configured to deliver solid, liquid or gaseous samples to the torch 100.

The auxiliary gas source 26 may include a supply of the auxiliary gas AG. The auxiliary gas AG may be any suitable gas from which the plasma P can be formed or generated as described herein. In some embodiments, the auxiliary gas AG is argon gas. In other embodiments, the auxiliary gas AG is nitrogen gas. The auxiliary gas source 26 is configured to provide a pressurized supply and flow of the auxiliary gas AG to the torch 100. The auxiliary gas source 26 may include a flow generator (e.g., a pump) and/or may contain a positively pressurized supply of the auxiliary gas AG.

The plasma gas source 28 may include a supply of the plasma gas PG. The plasma gas PG may be any suitable gas for serving the functions as described herein. In some embodiments, the plasma gas PG and the auxiliary gas AG have the same gas composition. In some embodiments, the plasma gas PG is argon gas. In other embodiments, the plasma gas PG is nitrogen gas. The plasma gas source 28 is configured to provide a pressurized supply and flow of the plasma gas PG to the torch 100. The plasma gas source 28 may include a flow generator (e.g., a pump) and/or may contain a positively pressurized supply of the plasma gas PG.

The torch 100 has a torch longitudinal axis A-A, a proximal end 106A and an axially opposing distal, terminal end 106T. The torch 100 includes a flow control subassembly, unit or system 110 and an induction coil 150.

The flow control system 110 has a flow control axis B-B, a proximal end 112A, an axially opposing distal, terminal end 112T. In some embodiments, the axes A-A and B-B are coaxial.

The flow control system 110 includes an injector tube 120, an intermediate tube 130, and a plasma tube 140. The intermediate tube 130 circumferentially surrounds the injector tube 120, and the plasma tube 140 circumferentially surrounds the intermediate tube 130. The injector tube 120, the intermediate tube 130, and the plasma tube 140 terminate at distal, terminal ends 120T, 130T, and 140T, respectively, proximate the torch terminal end 106T. In some embodiments, the injector tube 120, the intermediate tube 130, and the plasma tube 140 are substantially concentric about the torch axis A-A. In some embodiments, the tubes 120, 130 and 140 form a unitary member.

In some embodiments, the injector tube 120, the intermediate tube 130, and the plasma tube 140 are each substantially cylindrical and circular in cross-section. The injector tube 120 has an inlet 122 and an outlet 124. The intermediate tube 130 has an inlet 132 and an outlet 134. The plasma tube 140 has an inlet 142 and an outlet 144.

The injector tube 120 defines an axially extending sample passage 126 fluidly connecting the inlet 122 and the outlet 124. An annular, radial gap G1 is defined between the outer surface of the injector tube 120 and the inner surface of the intermediate tube 130. The gap G1 defines or forms an axially extending, tubular auxiliary gas passage 136 between the opposing surfaces of the injector tube 120 and the intermediate tube 130. The auxiliary gas passage 136 fluidly connects the inlet 132 and the outlet 134. An annular, radial gap G2 is defined between the outer surface of the intermediate tube 130 and the inner surface of the plasma tube 140. The gap G2 defines or forms an axially extending, tubular plasma gas passage 146 between the opposing surfaces of the intermediate tube 130 and the plasma tube 140. The plasma gas passage 146 fluidly connects the inlet 142 and the outlet 144.

In some embodiments, the nominal width W1 (FIG. 1) of the gap G1 is in the range of from about 2 mm to 4 mm. In some embodiments, the nominal width W2 (FIG. 1) of the gap G2 is in the range of from about 0.8 mm to 1.5 mm.

The sample source 24, the auxiliary gas source 26, and the plasma gas source 28 may be fluidly coupled to the inlet 122, the inlet 132, and the inlet 142, respectively, by corresponding conduits 29.

The induction coil 150 (which may also be referred to an as a load coil or work coil) is electrically connected to the radio-frequency (RF) power supply 22. The RF power supply 22 is configured to provide RF energy or electric current into and through the induction coil 150. In some embodiments, the induction coil 150 is a helically wound coil. In some embodiments, the induction coil 150 is formed of a suitable material, such as copper or aluminum.

In some embodiments, the induction coil 150 includes an electrical conductor 151 that is helically wound into a plurality of windings or turns 153 (i.e., the induction coil 150 is a helically wound coil). The induction coil 150 extends from a proximal end 152A to an opposing distal, terminal end 152T. In some embodiments and as illustrated, the proximal end 152A is defined by the first turn 153 and the distal end 152T is defined by the last turn 153. In some embodiments, the induction coil 150 has a coil axis C-C that is substantially coaxial with the torch axis A-A. In some embodiments, the induction coil 150 has a length L1 (FIG. 1) in the range of from about 16 mm to 20 mm.

In some embodiments, the injector tube 120 and the intermediate tube 130 are relatively arranged and configured such that the terminal end 130T of the intermediate tube 130 extends forwardly of the terminal end 120T of the injector tube 120 a distance L2 (FIG. 1). In some embodiments, the distance L2 is at least 0.5 mm and, in some embodiments, is in the range of from about 1 mm to 4 mm.

The intermediate tube 130 and the plasma tube 140 are relatively arranged and configured such that the terminal end 140T of the plasma tube 140 extends forwardly of the terminal end 130T of the intermediate tube 130 a distance L3 (FIG. 1). In some embodiments, the distance L3 is at least 13 mm and, in some embodiments, is in the range of from about 10 mm to 25 mm.

In some embodiments and as illustrated in FIG. 1, the plasma tube 140 and the induction coil 150 are relatively arranged and configured such that the terminal end 152T of the induction coil 150 extends forwardly of the outlet opening 144 of the plasma tube 140 a distance L4 (FIG. 1). In some embodiments, the distance L4 is at least 0.5 mm and, in some embodiments, is in the range of from about 1 mm to 5 mm. That is, the outlet opening 144 is rearwardly inset from the distal end 152T of the induction coil 150 the distance L4. In some embodiments and as shown in FIG. 1, the outlet opening 144 is located within the induction coil 150 (i.e., axially between the ends 152A and 152T).

In some embodiments and as illustrated in FIG. 1, the plasma tube 140 and the induction coil 150 are relatively arranged and configured such that the terminal end 152T of the induction coil 150 extends forwardly of the terminal end 140T of the plasma tube 140 a distance L5. In some embodiments, the distance L5 is at least 0.5 mm and, in some embodiments, is in the range of from about 1 mm to 5 mm. That is, the terminal end 140T is rearwardly inset from the distal end 152T of the induction coil 150 the distance L5. In some embodiments and as shown in FIG. 1, the terminal end 140T of the plasma tube 140 is located within the induction coil 150 (i.e., axially between the ends 152A and 152T).

In some embodiments and as illustrated in FIG. 1, the outlet opening 144 is axially coincident with the terminal end 140T, in which case the inset distances L4 and L5 are the same.

In some embodiments and as illustrated in FIG. 1, the outlet opening 144 is aligned with (i.e., centered on) the torch axis A-A.

In use, the sample gas SG is flowed through the sample gas passage 126, the auxiliary gas AG is flowed through the auxiliary gas passage 136, and the plasma gas PG is flowed through the plasma gas passage 146 in the direction F. It will be appreciated that the auxiliary gas stream AG is segregated from the sample gas stream SG by the injector tube 120 until the injector tube outlet 124, and is segregated from the plasma gas stream PG by the intermediate tube 130 until the outlet 134.

The induction coil 150 is powered to inductively heat the auxiliary gas stream AG in a coil induction region RI within the induction coil 150. An electric spark may be applied for a short time to introduce free electrons into the auxiliary gas stream AG. The auxiliary gas AG is thereby energized into a plasma P. The plasma P may generally include a plasma base PB, an analytical zone AZ, and a plasma tail or recombination zone RZ. The sample gas stream SG may enter the plasma P, where the sample gas stream evaporates and the molecules of the sample of interest break apart and the constituent atoms ionize (e.g., in the analytical zone AZ).

In some embodiments, the plasma P has a temperature of at least 4000 degrees Celsius and, in some embodiments, a temperature in the range of from about 5000 to 7000 degrees Celsius.

The plasma gas stream PG generally flows along the inner wall of the plasma tube 140 to form a tubular curtain or sheath between the plasma P and the plasma tube 140 in a plasma gas separation zone PZ.

In other embodiments, the plasma tube 140 and the induction coil 150 are relatively arranged and configured such that the terminal end 152T of the induction coil 150 and the terminal end 130T of the plasma tube 140 are axially coincident (i.e., located at the same position along the torch axis A-A). That is, the distance L1 (FIG. 1) is zero and the terminal end 130T is not inset from or projecting beyond the terminal end 152T.

As discussed above, the configuration of the torch 100 can prevent or inhibit overheating of the plasma tube 140 sufficient to melt the terminal end of the plasma tube 140. The plasma tube 140 ends prior to the hottest portions of the plasma P.

The injector tube 120 may be formed of suitable material. In some embodiments, the injector tube 120 is formed of quartz, sapphire or platinum.

The auxiliary tube 130 may be formed of suitable material. In some embodiments, the auxiliary tube 130 is formed of quartz.

The plasma tube 140 may be formed of suitable material. In some embodiments, the injector tube 120 is formed of quartz.

In some embodiments, the plasma tube 140 includes an opaque material at least in the portion 143 of the plasma tube 140 adjacent its terminal end 140T. In some embodiments, the portion 143 includes an opaque material having a higher melting point than quartz. In some embodiments, the portion 143 includes silicon nitride or ceramic. Because the plasma tube 140 terminates at or inset from the end 152T of the induction coil 150, the opaque end portion 143 does not block an operator's view of the plasma P extending axially forward of the induction coil 150.

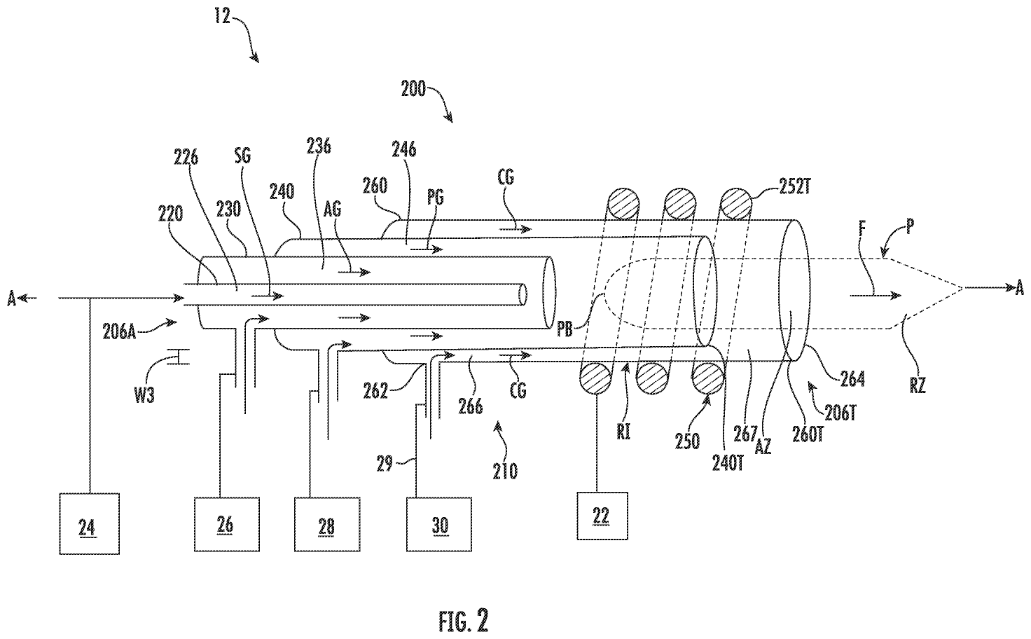

With reference to FIGS. 2-4, an ICP torch system 12 according to further embodiments is shown therein. The ICP torch system 12 includes a radiofrequency power generator 22, a sample source 24, an auxiliary gas source 26, and a plasma gas source 28 corresponding to the like numbered components of the ICP torch system 10. The ICP torch system 12 further includes a torch 200 and a confining gas source 30. The torch 200 includes a flow control subassembly, unit or system 210 and an induction coil 250. The flow control system 210 includes an injector tube 220, an intermediate tube 230, and a plasma tube 240 corresponding to the injector tube 120, the intermediate tube 130, and the plasma tube 140, respectively. The components 22, 24, 26, 28, 220, 230, 240, and 250 are constructed and connected and operate in the same manner as described herein with regard to the ICP torch system 10.

The ICP torch system 12 further includes confining gas tube 260 forming a part of the flow control system 210. The torch 200 has a torch axis A-A, a proximal end 206A and an axially opposing distal, terminal end 206T. In use, a flow or stream of a confining gas CG (from the confining gas source 30) is additionally forced or flowed through the torch 200 in the forward direction F toward the distal end 206T of the torch 200.

The confining gas source 30 may include a supply of a confining gas CG. The confining gas CG may be any suitable gas for serving the functions as described herein. In some embodiments, the confining gas CG includes air. In other embodiments, the confining gas CG is nitrogen, oxygen, or a mixture of both. The confining gas source 30 is configured to provide a pressurized supply and flow of the confining gas CG to the torch 200. The confining gas source 30 may include a flow generator (e.g., a pump) and/or may contain a positively pressurized supply of the confining gas CG.

The confining gas tube 260 terminates at a distal, terminal end 260T proximate the torch terminal end 206T. In some embodiments, the confining gas tube 260 is also substantially concentric about the torch axis A-A. In some embodiments, the confining gas tube 260 substantially cylindrical and circular in cross-section.

The confining gas tube 260 circumferentially surrounds the plasma tube 240. An annular, radial gap G3 is defined between outer surface of the plasma tube 140 and the inner surface of the confining gas tube 260. The gap G3 defines or forms an axially extending, tubular confining gas passage 266 between the opposing surfaces of the plasma tube 240 and the confining gas tube 260. The confining gas passage 266 fluidly connects the inlet 262 and the outlet 264.

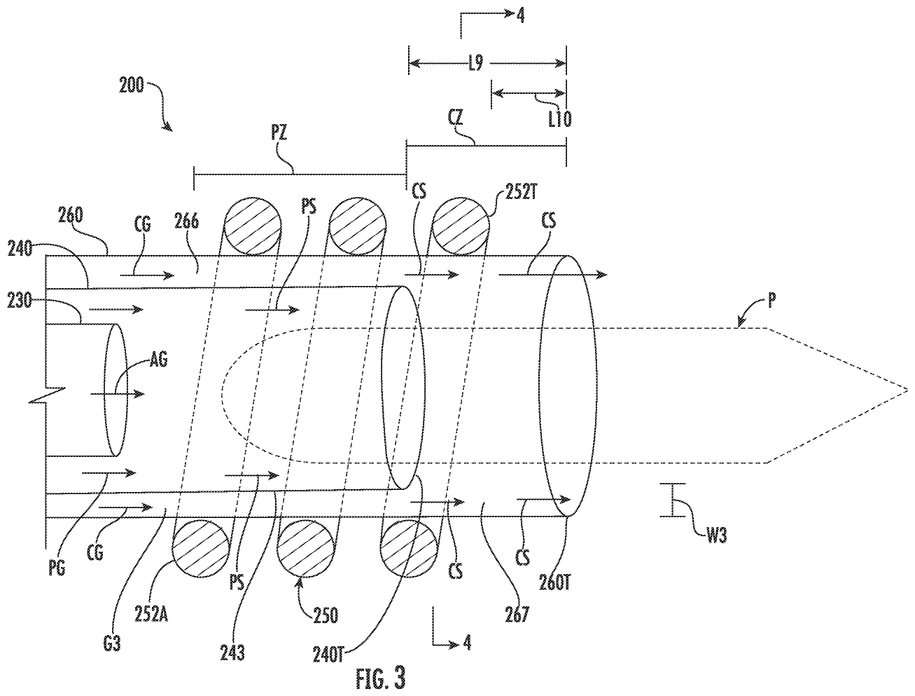

In some embodiments, the nominal width W3 (FIG. 3) of the gap G3 is at least 0.5 mm and in some embodiments, is in the range of from about 1 mm to 2.5 mm.

The confining gas source 30 may be fluidly coupled to the inlet 262 by a conduit 29 (FIG. 2).

In some embodiments, the tubes 220, 230, 240, and 260 form a unitary member.

The plasma tube 240 and the confining gas tube 260 are relatively arranged and configured such that the terminal end 260T of the confining tube 260 extends or protrudes forwardly of the terminal end 240T of the plasma tube 240 a distance L9 (FIG. 3). That is, a section 267 of the confining gas tube 260 projects or protrudes forwardly beyond the plasma tube 240. In some embodiments, the distance L9 is at least 3 mm and, in some embodiments, is in the range of from about 2 mm to 9 mm.

In some embodiments and as illustrated in FIG. 3, the confining gas tube 260 and the induction coil 250 are relatively arranged and configured such that the terminal end 260T of the confining gas tube 260 extends forwardly of the distal terminal end 252T of the induction coil 250 a distance L10 (FIG. 3). In some embodiments, the distance L10 is at least 3 mm and, in some embodiments, is in the range of from about 2 mm to 10 mm. That is, the terminal end 260T protrudes forwardly beyond the distal end 252T of the induction coil 250 the distance L10.

In other embodiments, the confining gas tube 260 and the induction coil 150 are relatively arranged and configured such that the terminal end 252T of the induction coil 250 and the terminal end 260T of the confining gas tube 260 are axially coincident (i.e., located at the same position along the torch axis A-A). That is, the distance L10 (FIG. 3) is zero and the confining gas tube 260 does not protrude forwardly beyond the terminal end 252T.

In use, the torch system 12 is operated in substantially the same manner as described above for the torch system 10, except for the additional provision of a confining gas stream CG. The sample gas SG is flowed through the sample gas passage 226, the auxiliary gas AG is flowed through the auxiliary gas passage 236, and the plasma gas PG is flowed through the plasma gas passage 246 in the forward direction F. Additionally, the confining gas CG is flowed through the confining gas passage 266 in the forward direction F. The auxiliary gas stream AG is segregated from the sample gas stream SG by the injector tube 220 until the injector tube outlet 224, and is segregated from the plasma gas stream PG by the intermediate tube 230 until the outlet 234. The plasma gas stream PG is segregated from the confining gas stream CG by the plasma tube 240 until the plasma tube outlet 244.

The induction coil 250 is powered to inductively heat the auxiliary gas stream AG in a coil induction region RI (FIG. 2) within the induction coil 250. An electric spark may be applied for a short time to introduce free electrons into the auxiliary gas stream AG. The auxiliary gas AG is thereby energized into a plasma P. The plasma P may generally include a plasma base PB, an analytical zone AZ, and a plasma tail or recombination zone RZ. The sample gas stream SG may enter the plasma P, where the sample gas stream evaporates and the molecules of the sample of interest break apart and the constituent atoms ionize (e.g., in the analytical zone AZ).

The plasma gas stream PG flows along the inner wall of the plasma tube 240 to form a tubular plasma gas curtain or sheath PS between the plasma P and the plasma tube 240 in a plasma gas separation zone PZ (FIG. 3).

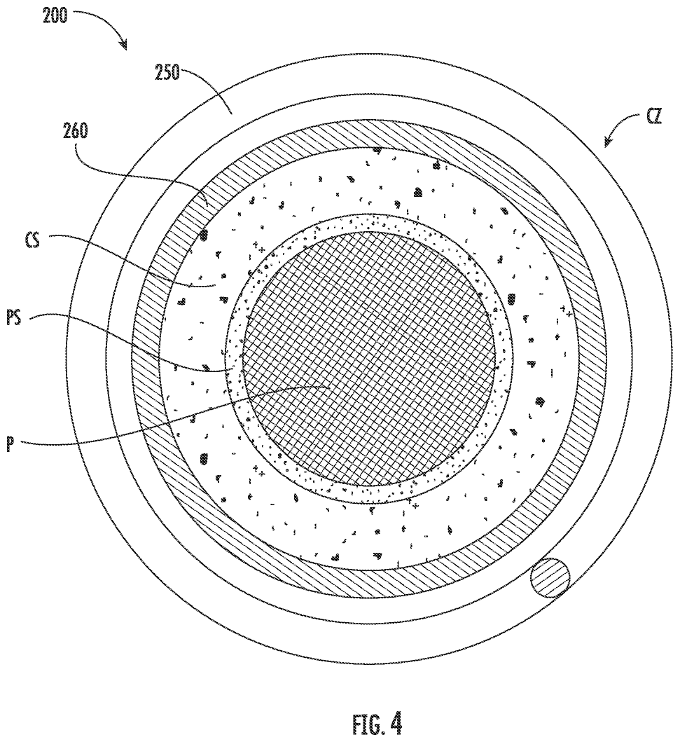

The confining gas stream CG flows along the inner wall of the confining gas tube 260 to form a tubular confining gas curtain or sheath CS (FIGS. 3 and 4) between the plasma P and the confining gas tube 260 in a confinement zone CZ downstream of the plasma tube terminal end 240T. Because the confining gas tube 260 is radially interposed between the plasma P and the induction coil 250, the confining gas sheath CS also separates the plasma P from the induction coil 250. The induction coil 250 is thus shielded from contact with the plasma by the confining gas sheath CS and the confining gas tube 260. The confining gas sheath CS provides a thermal buffer between the plasma P and the confining gas tube 260. The bulk flow of the confining gas sheath CS also convectively transfers heat from the plasma P out of the torch 200, away from the confining gas tube 260.

In some embodiments, the confining gas stream CG cools the confining gas tube 260.

The confining gas sheath CS and the confining gas tube 260 also serve to prevent the plasma gas from diffusing into the induction coil 250.

The confining gas sheath CS and the confining gas tube 260 may also serve to focus the plasma P or maintain the density and shape of the plasma P in the confinement zone CZ. This may improve the robustness of the plasma P.

Although the plasma tube 240 and the plasma gas sheath PS may not be necessary to protect the induction coil 250 from the plasma P, the plasma tube 240 and the plasma gas sheath PS may serve to ensure that the composition of the gas(es) delivered to the plasma region are suitable for ignition and analysis. The plasma tube 240 delivers the auxiliary gas AG to the interior of the induction coil 250.

For example, in some embodiments the auxiliary gas AG and the plasma gas PG are both argon gas. In this case mixing between the gas streams AG and PG does not dilute the argon concentration, ensuring that the argon concentration of the gas at the point of plasma ignition (within the induction coil 250, near the proximal end 252A) is sufficient to be ignited and sustain the plasma base PB. Once the argon gas is ignited, the ionized argon (i.e., plasma) will be electrically conductive to absorb more RF power from the remainder of the induction coil 250 to sustain a stable plasma. If too much of another gas (e.g., nitrogen) became mixed in with the argon gas, ignition of the plasma may be prevented by the greater energy requirement to ignite the mixed gas.

Similarly, the plasma tube 240 and the plasma gas sheath PS can prevent air or other undesired material from becoming entrained in or diffusing into the region of the torch 200 where the plasma P is analytically helpful.

Because the confining gas stream CG is segregated and from the gas supply to the plasma P by the plasma tube 240, and is segregated from the plasma P by the plasma gas sheath PS, the confining gas CG can be selected from a wider range of potential gases without undermining the performance of the torch 200. In particular, the selected confining gas CG material may be a gas that has higher thermal conductivity and/or lower cost than the plasma gas

PG.

The confining gas CG may be any suitable gas or mixture of gases. In some embodiments, the confining gas CG includes nitrogen gas. In some embodiments, the confining gas CG includes carbon dioxide gas. In some embodiments, the confining gas CG includes argon gas. In some embodiments, the confining gas CG includes air. In some embodiments, the confining gas CG includes a mixture of two or more of nitrogen gas, carbon dioxide gas, oxygen gas, and argon gas.

The use of a confining gas CG material (e.g., nitrogen) that requires higher energy input to ionize than the auxiliary gas AG material (e.g., argon) can also enhance the ability of the confining gas sheath CS to confine, shape or focus the plasma P and physically separate the plasma P from the confining tube 260. The confining gas sheath CS operates effectively as a chemical insulator about the formed plasma P that is less susceptible to ionization, thereby limiting or inhibiting radial expansion of the plasma P.

In some embodiments, the volumetric flow rate of the confining gas CG through the torch 200 is at least 7 liters/minute and, in some embodiments, is in the range of from about 4 to 10 liters/minute.

In some embodiments, the volumetric flow rate of the confining gas CG through the torch 200 is at least 1 times the volumetric flow rate of the plasma gas PG through the torch 200. In some embodiments, the volumetric flow rate of the confining gas CG through the torch 200 is in the range of from about 0.25 to 1.25 times the volumetric flow rate of the plasma gas PG through the torch 200.

In some embodiments, the volumetric flow rate of the plasma gas stream PG is less than 10 liters/minute and, in some embodiments, is in the range of from about 6 to 16 liters/minute.

In some embodiments, the volumetric flow rate of the sample stream SG is in the range of from about 0.8 to 1.2 liters/minute, the volumetric flow rate of the auxiliary gas stream AG is in the range of from about 0.5 to 1.2 liters/minute, the volumetric flow rate of the plasma gas stream PG is in the range of from about 6 to 16 liters/minute, and the volumetric flow rate of the confining gas stream CG is in the range of from about 4 to 10 liters/minute.

Advantageously, the provision of the confining gas sheath CS, the confining gas tube 260, and a truncated plasma tube 240 can significantly lower the consumption of argon or other plasma gas PG necessary to cool the torch 200 sufficiently to prevent melting of the torch. Because the plasma tube 240 is shortened relative to the induction coil 250, the plasma tube 250 is not exposed to the greater temperatures to which plasma tubes in conventional torches are subjected. The confining gas sheath CS and the confining gas tube 260 serve to protect the induction coil 250 from the portion of the plasma not separated by the shortened plasma tube 240, and to confine, focus or shape the plasma P in the region where the plasma is not controlled by the plasma tube 240.

The confining gas tube 260 may be formed of suitable material. In some embodiments, the confining gas tube 260 includes quartz, borosilicate glass, Pyrex glass, and/or ceramic (e.g., alumina).

In some embodiments, the confining gas tube 260 is substantially transparent or translucent. In some embodiments, the confining gas tube 260 is substantially transparent or translucent and the plasma tube 240 includes an opaque material at least in the portion 243 (FIG. 3) of the plasma tube 240 adjacent its terminal end 240T, as described above. In some embodiments, the portion 243 includes an opaque material having a higher melting point than quartz. In some embodiments, the portion 243 includes silicon nitride. Because the plasma tube 240 is shortened to an axial termination at or inset from the end 252T of the induction coil 250, the opaque end portion 243 does not block an operator's view of the plasma P extending axially forward of the induction coil 250. Because the confining gas tube 260 is substantially transparent or translucent, the portion of the plasma P extending axially forward of the induction coil 250 is visible through the confining gas tube 260.

In some embodiments, the confining gas CG is supplied to the torch 200 with a positive pressure to force the confining gas CG into and through the confining gas passage 266. For example, the confining gas CG may be supplied as compressed air or other gas from a liquid gas source. A gas regulator and mass flow meter may be provided to control the flow rate of the confining gas CG. In further embodiments, the confining gas CG may be supplied using a fan or pump.

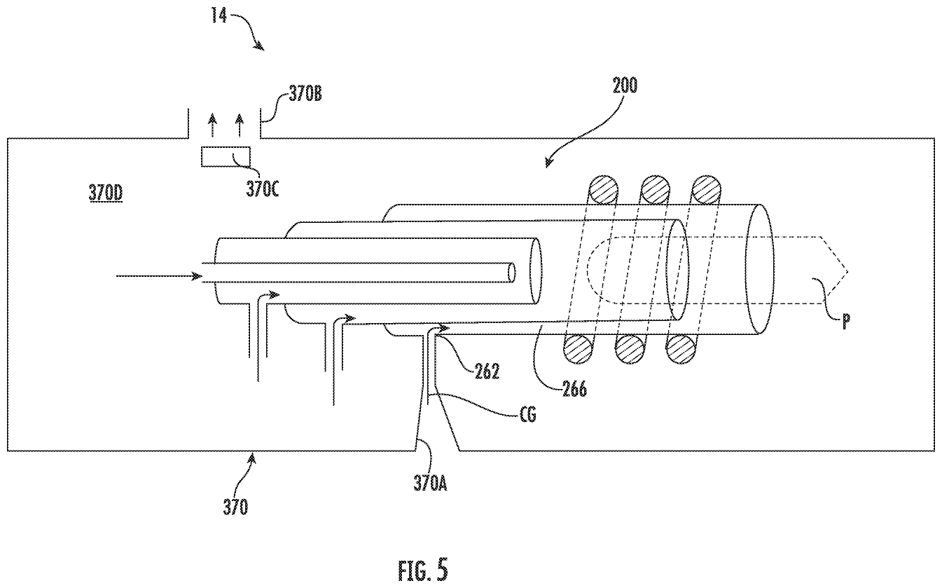

In some embodiments, the confining gas CG is supplied to the torch 200 using a negative pressure to draw the confining gas CG into and through the confining gas passage 266. In an example torch system 14 as shown in FIG. 5, the torch 200 is mounted in a torch enclosure 370. The torch enclosure 370 has an inlet 370A providing fluid communication between the confining gas tube inlet 262 and a confining gas supply (e.g., ambient air). The torch enclosure 370 defines a chamber 370D containing the torch 200, and an outlet 370B fluidly communicating with the chamber 370D. A ventilation fan or blower 370C is operable to pull the exhaust gases from the torch 200 out of the enclosure 370 through the outlet 370B. The suction from the ventilation fan 370C introduces a negative pressure that draws the confining gas CG into the confining gas tube inlet 262 and through the confining gas passage 266.

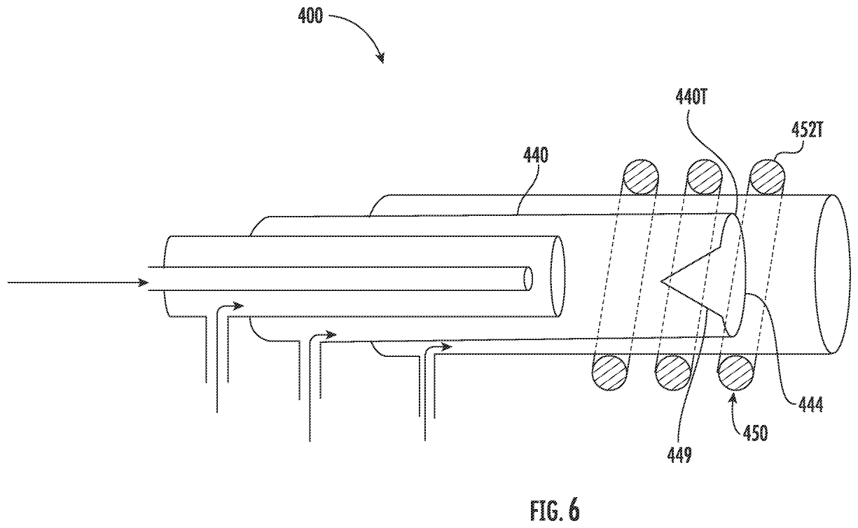

With reference to FIG. 6, a torch 400 according to further embodiments is shown therein. The torch 400 is constructed in the same manner as the torch 200, and may be used in the same manner as the torch 200, except as follows.

The plasma tube 440 of the torch 400 includes a radial side opening in the form of a side cut out opening 449 intersecting the terminal outlet opening 444 of the plasma tube 440. The plasma tube 440 and the induction coil 450 are relatively arranged and configured such that the terminal end 452T of the induction coil 450 is located forward of a portion of the cut out opening 449. At least a portion of the cut out opening 449 is located inside of the induction coil 450.

In the illustrated embodiment, the distal, terminal end 440T of the plasma tube 440 projects forwardly of the coil distal end 452T. However, in other embodiments, the terminal end 440T may also be coincident with or inset from the coil distal end 452T.

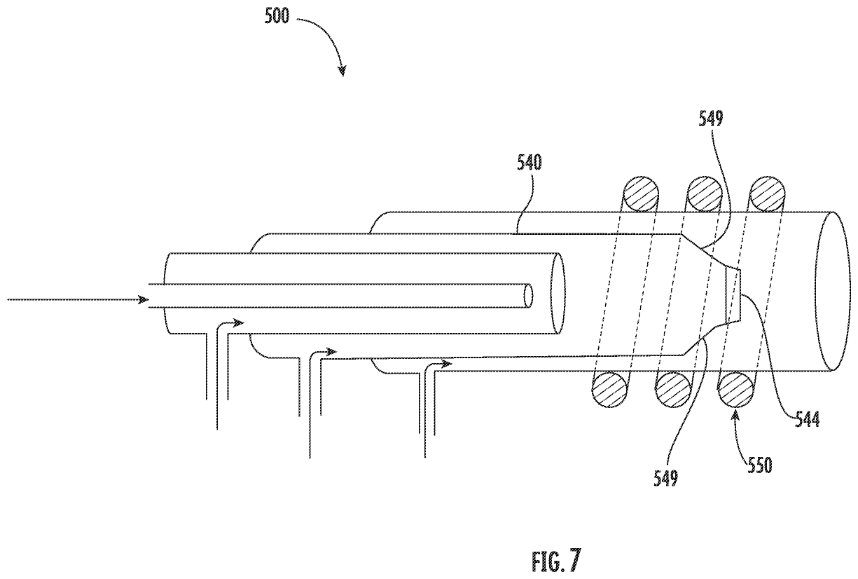

With reference to FIG. 7, a torch 500 according to further embodiments is shown therein. The torch 500 is constructed in the same manner as the torch 400, and may be used in the same manner as the torch 400, except that the torch 500 includes two side cut out openings 549 that intersect the terminal outlet opening 544 of the plasma tube 540 and have a portion located inside the induction coil 550.

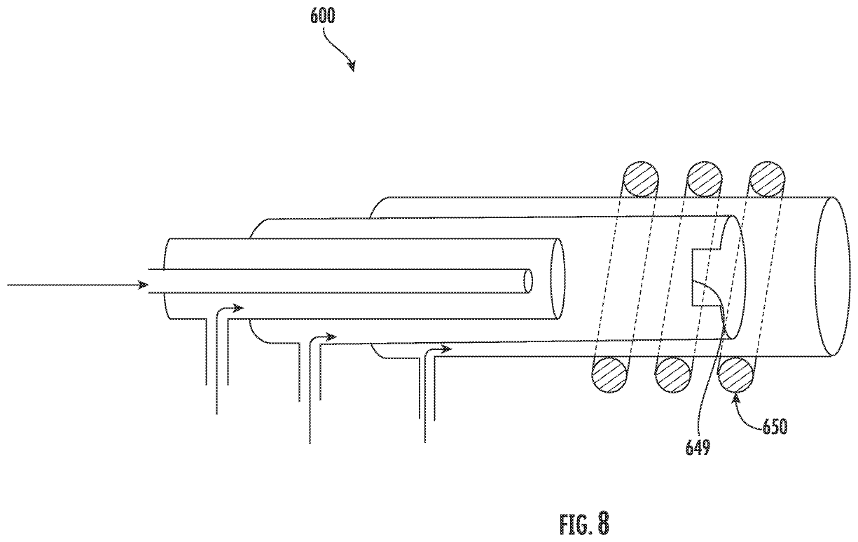

With reference to FIG. 8, a torch 600 according to further embodiments is shown therein. The torch 600 is constructed in the same manner as the torch 400, and may be used in the same manner as the torch 400, except that the torch 600 includes a side cut out opening 649 having an alternative shape. The side cut out 649 is located within the induction coil 650.

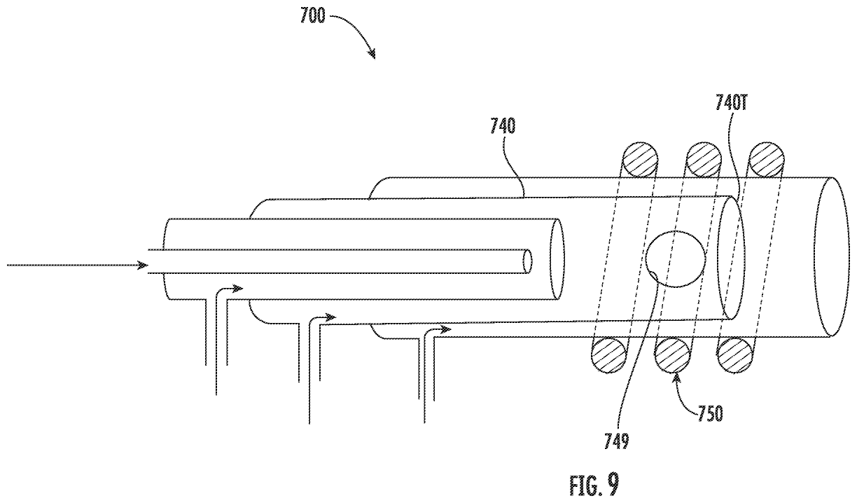

With reference to FIG. 9, a torch 700 according to further embodiments is shown therein. The torch 700 is constructed in the same manner as the torch 400, and may be used in the same manner as the torch 400, except that the torch 700 includes a radial side opening in the form of a side opening 749 that does not intersect the terminal end 740T of the plasma tube 740. The side opening 749 is located within the induction coil 750.

It will be appreciated that different numbers, shapes, and distributions of side cut outs and other openings may be employed.

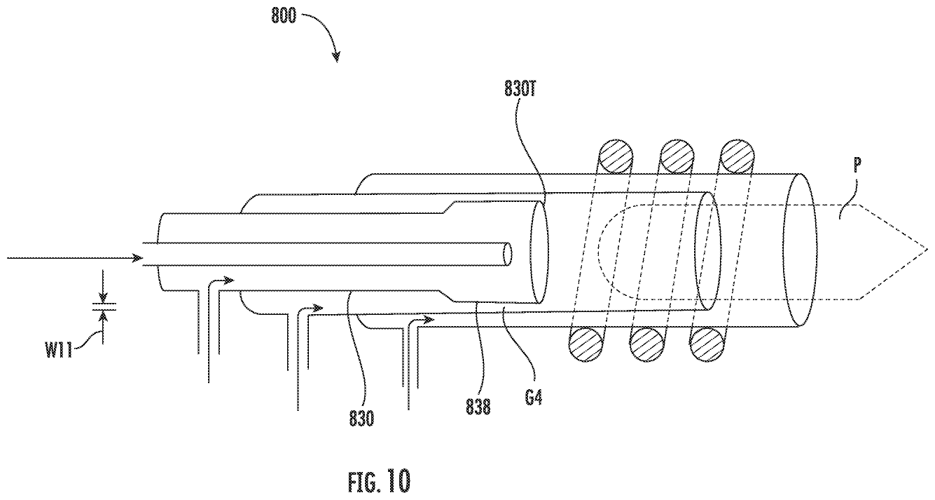

With reference to FIG. 10, a torch 800 according to further embodiments is shown therein. The torch 800 is constructed in the same manner as the torch 200, and may be used in the same manner as the torch 200, except as follows.

The auxiliary tube 830 of the torch 800 is provided with a radially enlarged distal end section 838. The increased outer diameter of the distal end section 838 creates a narrowed gap G4 in the plasma gas passage 846 proximate the distal end 830T of the auxiliary tube 830. In some embodiments, the width W11 of the narrowed gap G4 is in the range of from about 0.7 mm to 1.7 mm.

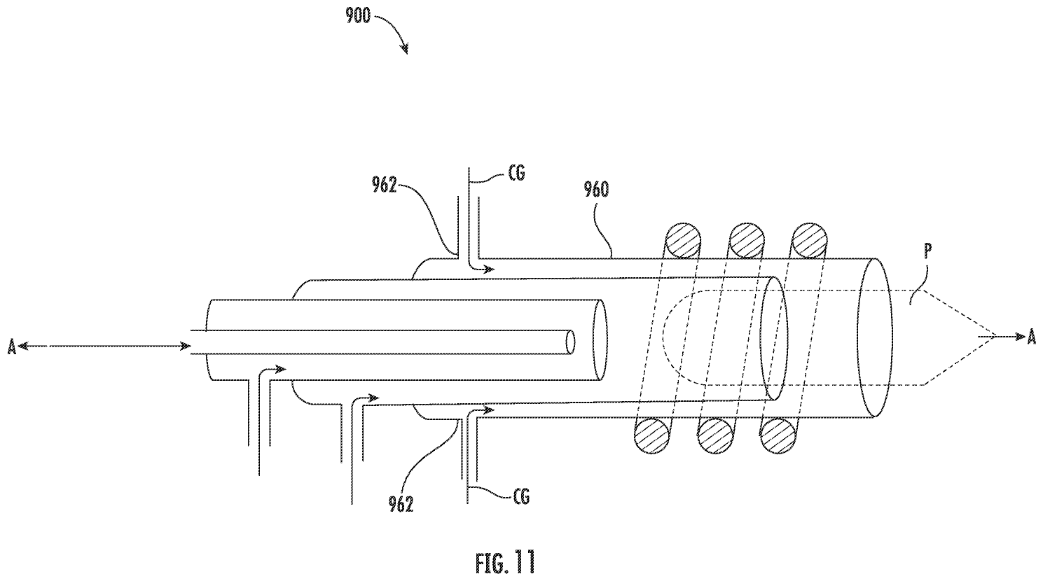

With reference to FIG. 11, a torch 900 according to further embodiments is shown therein. The torch 900 is constructed in the same manner as the torch 200, and may be used in the same manner as the torch 200, except as follows. In the torch 900, the confining gas tube 960 is provided with multiple confining gas tube inlets 962 through which the confining gas CG is flowed in. In the torch 900, the confining gas tube inlets 962 direct each of the incoming gas streams in a radial direction that substantially intersects the torch axis A-A.

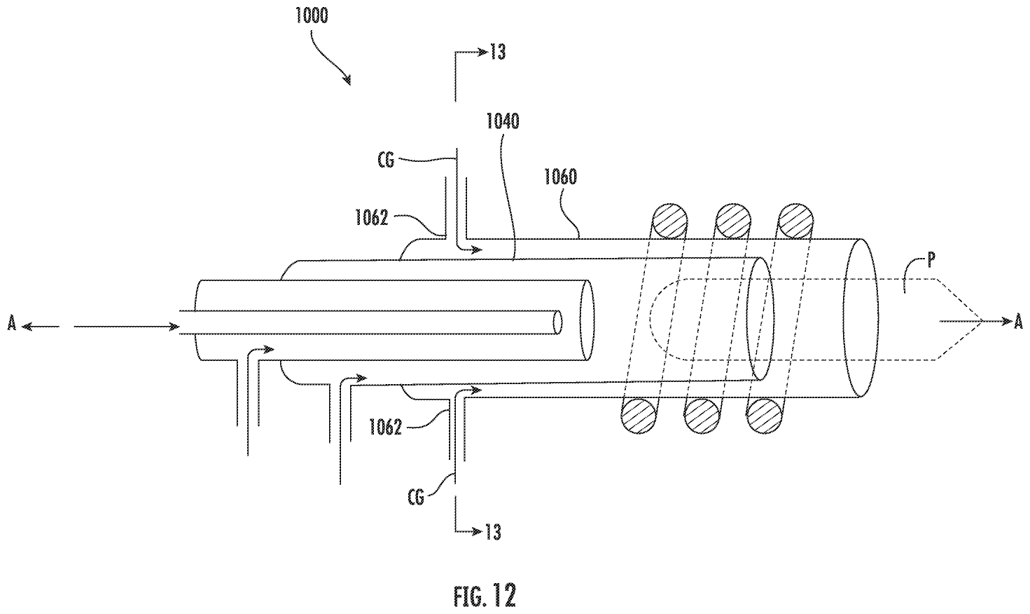

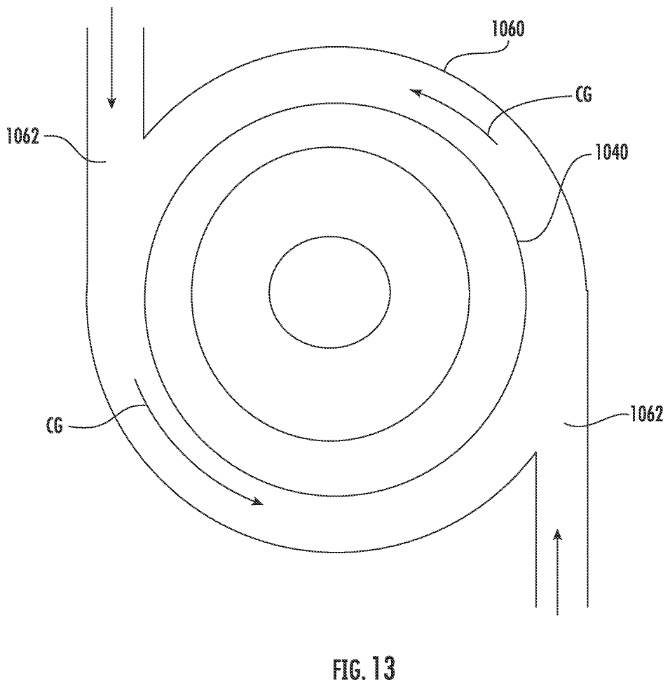

With reference to FIGS. 12 and 13, a torch 1000 according to further embodiments is shown therein. The torch 1000 is constructed in the same manner as the torch 900, and may be used in the same manner as the torch 900, except as follows. In the torch 1000, the confining gas tube 1060 is provided with multiple confining gas tube inlets 1062 through which the confining gas CG is flowed in. In the torch 1000, the confining gas tube inlets 1062 direct each of the incoming gas streams in a radial direction that is transverse to and radially offset from the torch axis A-A. This configuration may cause the confining gas stream to swirl helically about the plasma tube 1040.

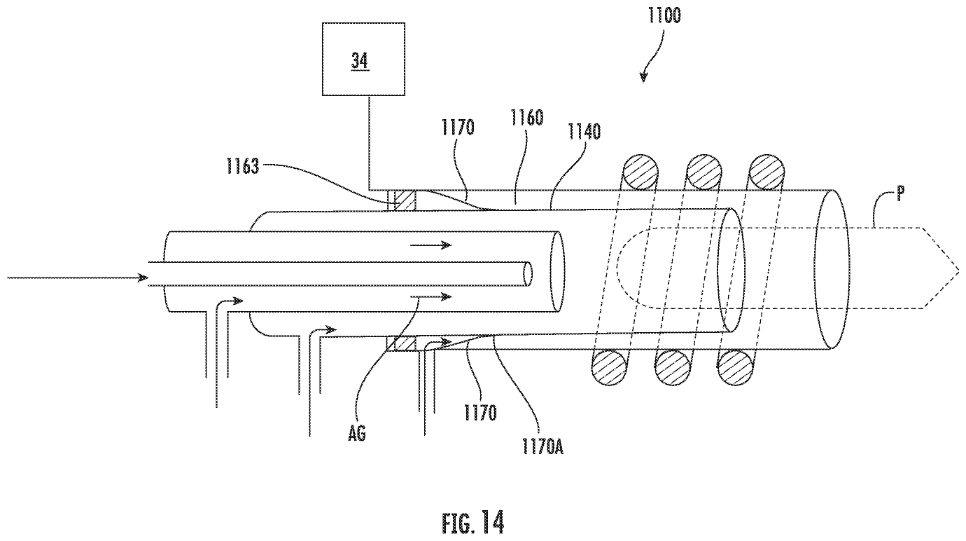

With reference to FIG. 14, a torch 1100 according to further embodiments is shown therein. The torch 1100 is constructed in the same manner as the torch 200, and may be used in the same manner as the torch 200, except as follows.

In the torch 1100, the confining gas tube 1160 is provided as a separate component that is removably secured to the remainder of the torch 1100. The confining gas tube 1160 is mechanically detachable from the plasma tube 1140. This may be useful to enable an operator to replace a damaged confining gas tube 1160, to re-install the confining gas tube 1160 on a new plasma tube 1140, or to replace the confining gas tube 1160 with a confining gas tube having a different size and/or shape, for example.

In some embodiments, an annular ring 1163 is mounted between the confining gas tube 1160 and the plasma tube 1140. The ring 1163 may serve as a mechanical coupling between the confining gas tube 1160 and the plasma tube 1140 that retains the tubes 1140, 1160 in proper alignment. In some embodiments, the ring 1163 serves as a fluid seal between the confining gas tube 1160 and the plasma tube 1140.

The ring 1163 may be formed of any suitable material(s). In some embodiments, the ring 1163 is formed of polyether ether ketone (PEEK).

The torch 1100 may further include metal plasma ignition electrodes 1170. The electrodes 1170 extend between the confining gas tube 1160 and the plasma tube 1140, and radially external of the plasma tube 1140. Each electrode 1170 includes a portion 1170A adjacent or contacting the outer surface of the plasma tube 1140. The ignition electrodes 1170 are electrically connected to a high voltage electrical power supply 34. In some embodiments, the power supply 34 is operable to generate a voltage between the electrodes 1170 and ground in the range of 1 kV or greater. In use, the power supply 34 and the electrodes are used to generate a spark or sparks in the auxiliary gas stream AG to initiate the creation of the plasma P.

In certain configurations, a torch as described herein can be used in a system configured to perform mass spectrometry (MS). For example and referring to FIG. 15, an ICP-MS device or system 1400 includes a sample introduction device 1420, an ICP torch 1410 as described herein that can be used to sustain an atomization/ionization source, a mass analyzer 1424, a detector or detection device 1426, a processing device 1428 and a display 1430. The torch 1410 may take any of the configurations described herein (e.g., any one of the torches 100-1200), for example. The system 1400 also includes (but not depicted in FIG. 15) an RF power supply 22, a sample supply, an auxiliary gas source 26, a plasma gas source 28, and a confining gas source 32 (in the case of a torch 1410 employing a confining gas stream CG as disclosed herein) operably connected to the torch 1410.

The sample introduction device 1420, the torch 1410, the mass analyzer 1424 and/or the detection device 1426 may be operated at reduced pressures using one or more vacuum pumps.

The sample introduction device 1420 may include an inlet system configured to provide sample to the torch 1410. The inlet system may include one or more batch inlets, direct probe inlets and/or chromatographic inlets. The sample introduction device 1420 may be an injector, a nebulizer or other suitable devices that may deliver solid, liquid or gaseous samples to the torch 1410.

The mass analyzer 1424 may take numerous forms depending generally on the sample nature, desired resolution, etc. and exemplary mass analyzers may comprise one or more rod assemblies such as, for example, a quadrupole or other rod assembly.

The detection device 1426 may be any suitable detection device that may be used with existing mass spectrometers, e.g., electron multipliers, Faraday cups, coated photographic plates, scintillation detectors, multi-channel plates, etc., and other suitable devices that will be selected by the person of ordinary skill in the art, given the benefit of this disclosure.

The processing device 1428 typically includes a microprocessor and/or computer and suitable software for analysis of samples introduced into the MS device 1400. One or more databases may be accessed by the processing device 1428 for determination of the chemical identity of species introduced into the MS device 1400.

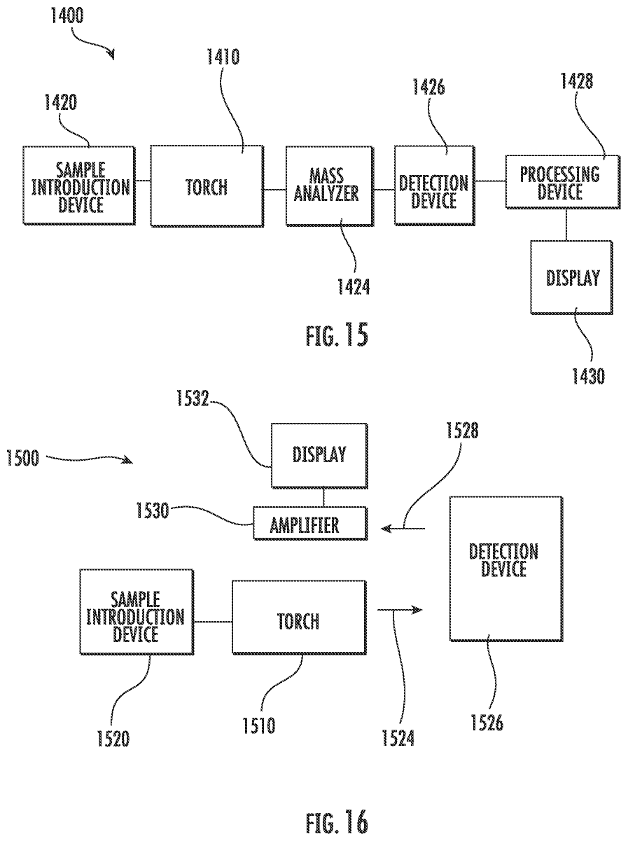

In certain configurations, an ICP torch described herein can be used in optical emission spectroscopy (OES). Referring to FIG. 16, an ICP-OES device or system 1500 includes a sample introduction device 1520, an ICP torch 1510 as described herein and optionally comprising one or more induction devices, and a detection device 1526. The torch 1510 may take any of the configurations described herein (e.g., any one of the torches 100-1200), for example. The system 1500 also includes (but not depicted in FIG. 16) an RF power supply 22, a sample supply, an auxiliary gas source 26, a plasma gas source 28, and a confining gas source 32 (in the case of a torch 1510 employing a confining gas stream CG as disclosed herein) operably connected to the torch 1510.

The sample introduction device 1520 may vary depending on the nature of the sample. In certain examples, the sample introduction device 1520 may be a nebulizer that is configured to aerosolize liquid sample for introduction into the torch 1510. In other examples, the sample introduction device 1520 may be an injector configured to receive sample that may be directly injected or introduced into the torch 1510. Other suitable devices and methods for introducing samples will be readily selected by the person of ordinary skill in the art, given the benefit of this disclosure.

The detector or detection device 1526 may take numerous forms and may be any suitable device that may detect optical emissions, such as optical emission 1524. For example, the detection device 1526 may include suitable optics, such as lenses, mirrors, prisms, windows, band-pass filters, etc. The detection device 1526 may also include gratings, such as echelle gratings, to provide a multi-channel OES device. Gratings such as echelle gratings may allow for simultaneous detection of multiple emission wavelengths. The gratings may be positioned within a monochromator or other suitable device for selection of one or more particular wavelengths to monitor. In certain examples, the detection device 1526 may include a charge coupled device (CCD). In other examples, the OES device 1500 may be configured to implement Fourier transforms to provide simultaneous detection of multiple emission wavelengths.

The detection device 1526 may be configured to monitor emission wavelengths over a large wavelength range including, but not limited to, ultraviolet, visible, near and far infrared, etc. The OES device 1500 may further include suitable electronics such as a microprocessor and/or computer and suitable circuitry to provide a desired signal and/or for data acquisition. Suitable additional devices and circuitry are known in the art and may be found, for example, on commercially available OES devices such as AVIO 200 series and AVIO 500 series OES devices commercially available from PerkinElmer Health Sciences, Inc. The optional amplifier 1530 e.g., a photomultiplier tube, may be operative to increase a signal 1528, e.g., amplify the signal from detected photons, and provides the signal to display 1532, which may be a readout, computer, etc. In examples where the signal 1528 is sufficiently large for display or detection, the amplifier 1530 may be omitted. In certain examples, the amplifier 1530 is a photomultiplier tube (PMT) configured to receive signals from the detection device 1526. Other suitable devices for amplifying signals, however, will be selected by the person of ordinary skill in the art, given the benefit of this disclosure. If desired the PMT can be integrated into the detector 1526.

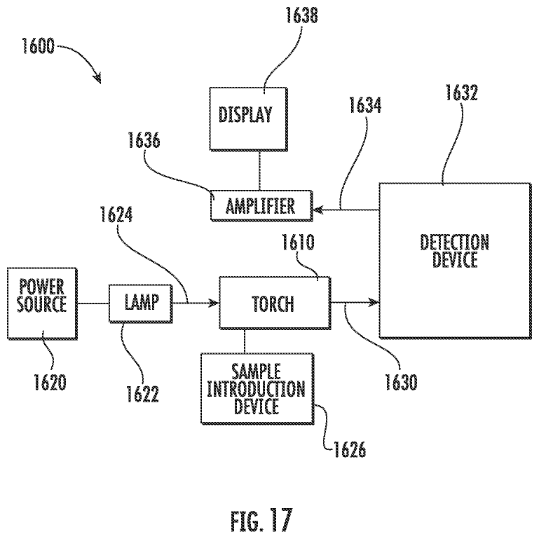

In certain examples, an ICP torch as described herein can be used in an atomic absorption spectrometer (AAS). Referring to FIG. 17, a single beam ICP-AAS 1600 comprises a power source 1620, a lamp 1622, a sample introduction device 1626, a torch 1610 as described herein, a detector or detection device 1632, an optional amplifier 1636 and a display 1638. The torch 1610 may take any of the configurations described herein (e.g., any one of the torches 100-1200), for example. The system 1600 also includes (but not depicted in FIG. 17) an RF power supply 22, a sample supply, an auxiliary gas source 26, a plasma gas source 28, and a confining gas source 32 (in the case of a torch 1610 employing a confining gas stream CG as disclosed herein) operably connected to the torch 1610.

The power source 1620 may be configured to supply power to the lamp 1622, which provides one or more wavelengths of light 1624 for absorption by atoms and ions. Suitable lamps include, but are not limited to mercury lamps, cathode ray lamps, lasers, etc. The lamp may be pulsed using suitable choppers or pulsed power supplies, or in examples where a laser is implemented, the laser may be pulsed with a selected frequency, e.g. 5, 10, or 20 times/second. The exact configuration of the lamp 1622 may vary. For example, the lamp 1622 may provide light axially along the torch 1610 or may provide light radially along the torch 1610. The example shown in FIG. 17 is configured for axial supply of light from the lamp 1622.

As sample is atomized and/or ionized in the torch 1610, the incident light 1624 from the lamp 1622 may excite atoms. That is, some percentage of the light 1624 that is supplied by the lamp 1622 may be absorbed by the atoms and ions in the torch 1610. The remaining percentage of the light 1630 may be transmitted to the detection device 1632. The detection device 1632 may provide one or more suitable wavelengths using, for example, prisms, lenses, gratings and other suitable devices such as those discussed above in reference to the OES devices, for example. The signal 1634 may be provided to the optional amplifier 1636 for increasing the signal provided to the display 1638. To account for the amount of absorption by sample in the torch 1610, a blank, such as water, may be introduced prior to sample introduction to provide a 100% transmittance reference value. The amount of light transmitted once sample is introduced into the torch 1610 may be measured, and the amount of light transmitted with sample may be divided by the reference value to obtain the transmittance.

AAS device 1600 may further include suitable electronics such as a microprocessor and/or computer and suitable circuitry to provide a desired signal and/or for data acquisition. Suitable additional devices and circuitry may be found, for example, on commercially available AAS devices such as AAS spectrometers commercially available from PerkinElmer Health Sciences, Inc.

Where the torch 1610 is configured to sustain an inductively coupled plasma, a radio frequency generator electrically coupled to an induction device may be present. In certain embodiments, a double beam AAS device, instead of a single beam AAS device could instead be used.

While certain shapes have been depicted in the drawings for the tubes of the torches (e.g., tubes 120, 130, 140, 260), these shapes are provided for illustrative purposes. It will be appreciated that other shapes may be employed in some embodiments of the technology.

The present technology has been described herein with reference to the accompanying drawings, in which illustrative embodiments of the technology are shown. In the drawings, the relative sizes of regions or features may be exaggerated for clarity. This technology may, however, be embodied in many different forms and should not be construed as limited to the embodiments set forth herein; rather, these embodiments are provided so that this disclosure will be thorough and complete, and will fully convey the scope of the technology to those skilled in the art.

It will be understood that, although the terms first, second, etc. may be used herein to describe various elements, components, regions, layers and/or sections, these elements, components, regions, layers and/or sections should not be limited by these terms. These terms are only used to distinguish one element, component, region, layer or section from another region, layer or section. Thus, a first element, component, region, layer or section discussed below could be termed a second element, component, region, layer or section without departing from the teachings of the present technology.

Spatially relative terms, such as “beneath”, “below”, “lower”, “above”, “upper” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” the other elements or features. Thus, the exemplary term “below” can encompass both an orientation of above and below. The device may be otherwise oriented (rotated 90° or at other orientations) and the spatially relative descriptors used herein interpreted accordingly.

As used herein, the singular forms “a”, “an” and “the” are intended to include the plural forms as well, unless expressly stated otherwise. It will be further understood that the terms “includes,” “comprises,” “including” and/or “comprising,” when used in this specification, specify the presence of stated features, integers, steps, operations, elements, and/or components, but do not preclude the presence or addition of one or more other features, integers, steps, operations, elements, components, and/or groups thereof. It will be understood that when an element is referred to as being “connected” or “coupled” to another element, it can be directly connected or coupled to the other element or intervening elements may be present. As used herein, the term “and/or” includes any and all combinations of one or more of the associated listed items.

Many alterations and modifications may be made by those having ordinary skill in the art, given the benefit of present disclosure, without departing from the spirit and scope of the invention. Therefore, it must be understood that the illustrated embodiments have been set forth only for the purposes of example, and that it should not be taken as limiting the invention as defined by the following claims. The following claims, therefore, are to be read to include not only the combination of elements which are literally set forth but all equivalent elements for performing substantially the same function in substantially the same way to obtain substantially the same result. The claims are thus to be understood to include what is specifically illustrated and described herein, what is conceptually equivalent, and also what incorporates the essential idea of the invention.

1. An inductively coupled plasma (ICP) torch, the ICP torch having a torch axis and a torch distal end, the ICP torch comprising:
an injector tube defining an injector flow passage to receive a flow of a sample fluid;
an intermediate tube disposed about the injector tube, wherein an auxiliary gas passage is defined between the injector tube and the intermediate tube and configured to receive a flow of an auxiliary gas;
a plasma tube disposed about the intermediate tube, wherein a plasma gas passage is defined between the intermediate tube and the plasma tube and configured to receive a flow of a plasma gas; and
an induction coil disposed about the plasma tube, the induction coil being configured to be supplied with radio-frequency electric current to inductively energize the auxiliary gas to produce a plasma proximate the torch distal end, the induction coil extending axially from a coil proximal end to a coil distal end proximate the torch distal end;
wherein the plasma tube includes an outlet opening proximate the torch distal end; and
wherein the outlet opening is at least partially coincident with or axially inset from the coil distal end.

2.-4. (canceled)

5. The ICP torch of claim 1 wherein the outlet opening of the plasma tube is disposed within the induction coil.

6. The ICP torch of claim 1 wherein a distal end of the plasma tube is coincident with or axially inset from the coil distal end.

7.-10. (canceled)

11. The ICP torch of claim 1 wherein the outlet opening is located at a distal end of the plasma tube and is aligned with the torch axis.

12. The ICP torch of claim 1 wherein the outlet opening is a radial side opening in the plasma tube.

13. (canceled)

14. The ICP torch of claim 1 wherein the auxiliary gas passage has a narrowed gap proximate a distal end of the auxiliary tube.

15.-17. (canceled)

18. The ICP torch of claim 1 including an ignition electrode disposed radially external of the plasma tube and operable to ignite a plasma in the flow of the auxiliary gas.

19. The ICP torch of claim 1 including a confining gas tube disposed about the plasma tube, wherein a confining gas passage is defined between the plasma tube and the confining gas tube to receive a flow of a confining gas.

20.-31. (canceled)

32. A method for generating a plasma, the method comprising:
providing an inductively coupled plasma (ICP) torch, the ICP torch having a torch axis and a torch distal end, the ICP torch including:
an injector tube defining an injector flow passage to receive a flow of a sample fluid;
an intermediate tube disposed about the injector tube, wherein an auxiliary gas passage is defined between the injector tube and the intermediate tube and configured to receive a flow of an auxiliary gas;
a plasma tube disposed about the intermediate tube, wherein a plasma gas passage is defined between the intermediate tube and the plasma tube and configured to receive a flow of a plasma gas; and
an induction coil disposed about the plasma tube, the induction coil extending axially from a coil proximal end to a coil distal end proximate the torch distal end;
wherein the plasma tube includes an outlet opening proximate the torch distal end; and
wherein the outlet opening is at least partially coincident with or axially inset from the coil distal end;
flowing the auxiliary gas through the auxiliary gas passage;
flowing the plasma gas through the plasma gas passage; and
supplying a radio-frequency electric current to the induction coil to inductively energize the auxiliary gas to produce a plasma proximate the torch distal end.

33. An inductively coupled plasma (ICP) torch, the ICP torch having a torch axis and a torch distal end, the ICP torch comprising:
an injector tube defining an injector flow passage to receive a flow of a sample fluid;
an intermediate tube disposed about the injector tube, wherein an auxiliary gas passage is defined between the injector tube and the intermediate tube and configured to receive a flow of an auxiliary gas;
a plasma tube disposed about the intermediate tube, wherein a plasma gas passage is defined between the intermediate tube and the plasma tube and configured to receive a flow of a plasma gas; and
a confining gas tube disposed about the plasma tube, wherein:
a confining gas passage is defined between the plasma tube and the confining gas tube to receive a flow of a confining gas; and
the confining gas tube protrudes distally beyond a distal end of the plasma tube.

34. The ICP torch of claim 33 including multiple inlets configured to direct the confining gas into the confining gas passage.

35.-37. (canceled)

38. The ICP torch of claim 33 wherein the plasma tube and the confining gas tube are formed of different materials from one another.

39.-40. (canceled)

41. The ICP torch of claim 33 including an induction coil disposed about the plasma tube, wherein:
the induction coil is configured to be supplied with radio-frequency electric current to inductively energize the auxiliary gas to produce a plasma proximate the torch distal end; and
the induction coil extends axially from a coil proximal end to a coil distal end proximate the torch distal end.

42. The ICP torch of claim 41 wherein a distal end of the confining gas tube is coincident with or protrudes distally beyond the coil distal end.

43.-44. (canceled)

45. An inductively coupled plasma (ICP) torch system comprising:
an ICP torch having a torch axis and a torch distal end, the ICP torch including:
an injector tube defining an injector flow passage to receive a flow of a sample fluid;
an intermediate tube disposed about the injector tube, wherein an auxiliary gas passage is defined between the injector tube and the intermediate tube and configured to receive a flow of an auxiliary gas;
a plasma tube disposed about the intermediate tube, wherein a plasma gas passage is defined between the intermediate tube and the plasma tube and configured to receive a flow of a plasma gas;
an induction coil disposed about the plasma tube, the induction coil being configured to be supplied with radio-frequency electric current to inductively energize the auxiliary gas to produce a plasma proximate the torch distal end, the induction coil extending axially from a coil proximal end to a coil distal end proximate the torch distal end; and
a confining gas tube disposed about the plasma tube, wherein:
a confining gas passage is defined between the plasma tube and the confining gas tube to receive a flow of a confining gas; and
the confining gas tube protrudes distally beyond a distal end of the plasma tube;
a supply of the auxiliary gas fluidly coupled to the auxiliary gas passage;
a supply of the plasma gas fluidly coupled to the plasma gas passage; and
a supply of the confining gas fluidly coupled to the confining gas passage.

46. The ICP torch system of claim 45 wherein the confining gas has a different chemical composition than the plasma gas.

47. The ICP torch system of claim 46 wherein the confining gas includes Nitrogen gas.

48. The ICP torch system of claim 46 wherein the plasma gas includes Argon gas.

49. The ICP torch system of claim 45 including a positive pressure source configured to supply the confining gas into the confining gas passage with a positive pressure to force the confining gas to flow through the confining gas passage.

50. The ICP torch system of claim 45 wherein the ICP torch system is configured to use a negative pressure to draw a flow of the confining gas through the confining gas passage.

51.-54. (canceled)
